(19) United States
(12) Patent Application Publication
(10) Pub. No.: US 2015/0090941 A1
(43) Pub. Date: Apr. 2, 2015

(54) METHOD FOR MANUFACTURING CONDUCTIVE POLYIMIDE FILM

(71) Applicant: KANEKA CORPORATION, Osaka-shi, Osaka (JP)

(72) Inventors: Kohei Ogawa, Settsu-shi (JP); Masami Yanagida, Settsu-shi (JP); Takashi Ito, Settsu-shi (JP)

(73) Assignee: KANEKA CORPORATION, Osaka-shi, Osaka (JP)

(21) Appl. No.: 14/394,650

(22) PCT Filed: Apr. 17, 2013
(86) PCT No.: PCT/JP2013/061360

§ 371 Date: Oct. 15, 2014

(30) Foreign Application Priority Data
Apr. 20, 2012 (JP) 2012-096654

(51) Int. Cl. H01B 1/24; H01B 13/30

(52) U.S. Cl. CPC H01B 1/24; H01B 13/30
USPC 252/511

(57) ABSTRACT

A conductive polyimide film having an excellent film strength and electrical properties can be manufactured in a high productivity by a method for manufacturing conductive polyimide film which includes, in a manufacture method of a conductive polyimide film including an agent for imparting conductivity and a polyimide resin, drying a coating film including (A) and (B); and subjecting the film to imidation. (A) A polyamic acid including 3,3′,4,4′-biphenyltetracarboxylic acid dianhydride, 4,4′-oxydianiline, and 3,3′,4,4′-benzophenonetetracarboxylic acid dianhydride and/or p-phenylenediamine, which is obtained by reacting a tetracarboxylic acid dianhydride with a diamine compound. (B) A agent for imparting conductivity. (C) An imidation accelerator including a dialkylpyridine, and 0.1 to 1.6 molar equivalents of acetic anhydride per mol of an amic acid in a polyamic acid.

### TECHNICAL FIELD

The present invention relates to a method for manufacturing a conductive polyimide film.

### BACKGROUND ART

Polyimide films having high mechanical strength, heat resistance, chemical resistance, and the like, and thus they are practicalized in a wide range of fields from the aerospace field to the electronic material field. Conductive polyimide films, obtained by imparting conductivity to the polyimide film, are useful as an alternative material to a metal electronic material, and they can be preferably used for, in particular, electromagnetic shielding materials, electrostatic attracting films, anti-static agents, parts for an image formation device, materials for a battery electrode, electronic devices, and the like. In order to meet the uses described above for a long time, the conductive polyimide film is required to have, at least, excellent electrical properties and excellent mechanical properties.

The conductive polyimide film is usually manufactured by the following steps.

(1) a step of flow-casting a polyamic acid solution in which an agent for imparting conductivity is dispersed on a support to form a coating film, and
(2) a step of performing of removal of a solvent by volatilization, and performing imidation.

Conventionally, after an agent for imparting conductivity such as carbon black is dispersed in a polar organic solvent, tetracarboxylic acid dianhydride and a diamine component are added thereto to react them, thereby obtaining a polyamic acid solution, and imidation is performed using the solution. The method, however, has problems such as low dispersibility and easy occurrence of aggregation of the agent for imparting conductivity.

Under such a circumstance, a method effective for a heat imidation in which the step (2) described above is performed substantially using heat alone is disclosed in, for example, Patent Document 1.

Specifically, Patent Document 1 proposes a method for manufacturing a polyamic acid solution in which carbon black is dispersed in a solvent, which is obtained by adding an amine compound having a low molecular weight to the solvent, thereby dispersing the carbon black having a specific conductivity index therein. In Examples thereof, the heat imidation is performed to obtain a semi-conductive polyimide belt.

In the heat-imidation, however, the step (2) in the polyimide film manufacture takes a very long time, and thus the productivity thereof tends to be poor.

### CITATION LIST

### Patent Literature

Patent Document 1: JP-A No. 2007-302769

### SUMMARY OF INVENTION

### Technical Problem

On the other hand, when the conductive polyimide film is manufactured by a chemical imidation, the chemical imidation has a special problem in which the agent for imparting conductivity such as carbon black is re-aggregated in the imidation or drying step, and thus an appropriate improvement is required for the chemical imidation method.

The method for manufacturing the conductive polyimide film by the chemical imidation, accordingly, has been studied, and it has been found that when 3,3′, 4,4′-biphenyltetracarboxylic acid dianhydride, 4,4′-oxydianiline, and 3,3′,4,4′-benzophenonetetracarboxylic acid dianhydride and/or p-phenylenediamine are used as a tetracarboxylic acid dianhydride and a diamine compound, the re-aggregation of the agent for imparting conductivity such as carbon black and generation of pin holes can be inhibited in the chemical imidation, and a conductive polyimide film having a desired electric resistivity can be manufactured.

It has been found that the use of isoquinoline as an imidation accelerator is especially preferable in terms of the film strength, but the isoquinoline is a by-product generated from distillation of tar, and there is limitation in the production amount thereof. It may possibly be difficult to obtain it when a large amount is necessary, and this becomes a problem for realizing the mass production.

The present invention aims at providing a method for manufacturing a conductive polyimide film having an excellent film strength and electrical properties in a high productivity.

### Solution to Problem

In view of the circumstances described above, the present inventors have repeated a painstaking study; as a result, it has been found that a method in which a polyamic acid including a specific tetracarboxylic acid dianhydride and a specific diamine compound is imidated with an imidation accelerator including a dialkylpyridine and acetic anhydride is effective. It has been found that according to the method, the obtained conductive polyimide film has a desired resistivity while the re-aggregation of the agent for imparting conductivity such as the carbon black and the generation of pin holes are inhibited, and the film has a film strength equivalent to that of a conductive polyimide film obtained using the isoquinoline; and the present invention has been completed.

The present invention relates to a method for manufacturing a conductive polyimide film including an agent for imparting conductivity and a polyimide resin, including:

drying a coating film which includes:
(A) a polyamic acid including 3,3′,4,4′-biphenyltetracarboxylic acid dianhydride, 4,4′-oxydianiline, and 3,3′,4,4′-benzophenonetetracarboxylic acid dianhydride and/or p-phenylenediamine,
which is obtained by reacting a tetracarboxylic acid dianhydride with a diamine compound,
(B) an agent for imparting conductivity, and
(C) an imidation accelerator including a dialkylpyridine and 0.1 to 1.6 molar equivalents of acetic anhydride per mol of an amic acid in a polyamic acid; and
subject the film to imidation.

In the method for manufacturing the conductive polyimide film of the present invention, it is preferable that, in the component (A), the 3,3′,4,4′-biphenyltetracarboxylic acid dianhydride and the 3,3′,4,4′-benzophenonetetracarboxylic acid dianhydride are included in contents of 10 to 100% by mol and 0 to 90% by mol, respectively, relative to 100% by mol of the tetracarboxylic acid dianhydride, and the 4,4′-oxydianiline and the p-phenylenediamine are included in contents of 50 to 100% by mol and 0 to 50% by mol, respectively, relative to 100% by mol of the diamine compound.

In the method for manufacturing the conductive polyimide film of the present invention, it is preferable that the agent (B) for imparting conductivity includes carbon conductive particles.

In the method for manufacturing the conductive polyimide film of the present invention, it is preferable that the agent (B) for imparting conductivity is included in an amount of 1 to 50 parts by weight based on 100 parts by weight of the polyamic acid (A).

In the method for manufacturing the conductive polyimide film of the present invention, it is preferable that the dialkylpyridine in the imidation accelerator (C) is used in an amount within a range of 0.1 to 4.0 molar equivalents per mol of the amic acid in the polyamic acid (A).

In the method for manufacturing the conductive polyimide film of the present invention, it is preferable that the conductive polyimide film has a thickness within range of 1 to 100 μm.

In the method for manufacturing the conductive polyimide film of the present invention, it is preferable that the conductive polyimide film has a volume resistivity within a range of 1.0×10⁻¹ to 1.0×10² Ωcm in a thickness direction and/or a surface resistivity within a range of 1.0×10¹ to 1.0×10⁴ Ω/□.

In the method for manufacturing the conductive polyimide film of the present invention, it is preferable that the conductive polyimide film has a tear propagation resistance within a range of 130 to 250 g/mm (1.27 to 2.45 N/mm).

### Advantageous Effects of Invention

According tot he manufacture method of the present invention, a conductive polyimide film having an excellent film strength and electrical properties can be manufactured in a high productivity.

The manufacture method of the present invention is appropriate to a mass production of a conductive polyimide film having a desired resistivity.

### DESCRIPTION OF EMBODIMENTS

One embodiment of the present invention is explained as below, but the present invention is not limited thereto.

The polyamic acid (A) used in the manufacture method of the present invention is a product obtained by reaction of a diamine compound with a tetracarboxylic acid dianhydride, and is characterized by including 3,3′,4,4′-biphenyltetracarboxylic acid dianhydride and 4,4′-oxydianiline as the tetracarboxylic acid dianhydride and the diamine compound, and further including 3,3′,4,4′-benzophenonetetracarboxylic acid dianhydride and/or p-phenylenediamine.

In the manufacture method of the present invention, it is only necessary to use at least 3,3′,4,4′-biphenyltetracarboxylic acid dianhydride, the 4,4′-oxydianiline, and 3,3′,4,4′-benzophenonetetracarboxylic acid dianhydride and/or p-phenylenediamine are included as the diamine compound component and the tetracarboxylic acid dianhydride component, and tetracarboxylic acid dianhydride and/or diamine compound other than the components described above may be used together with them to modify the polyamic acid in a range where the effects of the present invention are not impaired.

As the tetracarboxylic acid dianhydride, in addition to 3,3′,4,4′-biphenyltetracarboxylic acid dianhydride and 3,3′,4,4′-benzophenonetetracarboxylic acid dianhydride, it is possible to use, for example, pyromellitic acid dianhydride, 2,3,6,7-naphthalenetetracarboxylic acid dianhydride, 1,2,5,6-naphthalenetetracarboxylic acid dianhydride, 2,3,3′,4′-biphenyltetracarboxylic acid dianhydride, 2,2′,3,3′-biphenyltetracarboxylic acid dianhydride, 4,4′- oxyphthalic acid dianhydride, 2,2-bis(3,4-dicarboxyphenyl)propane dianhydride, 2,2-bis(4-phenoxyphenyl)propanetetracarboxylic acid dianhydride, 3,4,9,10-perylenetetracarboxylic acid dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride, oxydiphthalic acid dianhydride, bis(3,4-dicarboxyphenyl)sulfone dianhydride, p-phenylene bis(trimellitic acid monoester acid anhydride), ethylene bis(trimellitic acid monoester acid anhydride), bisphenol A bis(trimellitic acid monoester acid anhydride), and analogues thereof. Of these, it is preferable to use the pyromellitic acid dianhydride, 4,4′-oxyphthalic acid dianhydride, 2,3,3′,4′-biphenyltetracarboxylic acid dianhydride, and 2,2-bis(4-phenoxyphenyl)propanetetracarboxylic acid dianhydride, because they are easily industrially obtained. They may be used alone or as a mixture of two or more kinds.

As the diamine compound, in addition to the 4,4′-oxydianiline and p-phenylenediamine, for example, 4,4′-diaminodiphenyl propane, 4,4′-diaminodiphenylmethane, benzidine, 3,3′-dichlorobenzidine, 3,3′-dimethylbenzidine, 2,2′-dimethylbenzidine, 3,3′-dimethoxybenzidine, 2,2′-dimethoxybenzidine, 4,4′-diaminodiphenyl sulfide, 3,3′-diaminodiphenyl sulfone, 4,4′-diaminodiphenyl sulfone, 3,3′-oxydianiline, 3,4′-oxydianiline, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl-N-methyl amine, 4,4′-diaminodiphenyl-N-phenyl amine, 1,3-diaminobenzene, 1,2-diaminobenzene, bis{4-(4-aminophenoxy)phenyl}sulfone, bis{4-(4-aminophenoxy)phenyl}propane, bis{4-(3-aminophenoxy)phenyl}sulfone, 4,4′-bis(4-aminophenoxy)biphenyl, 4,4′-bis(3-aminophenoxy)biphenyl, 1,3-bis(3-aminophenoxy)benzene, 1,3-bis(4-aminophenoxy)benzene, 3,3′-diaminobenzophenone, 4,4′-diaminobenzophenone, and analogues thereof may be used. Of these, it is preferable to use the 4,4′-diaminodiphenylpropane, 4,4′-diaminodiphenylmethane, 4,4′-diaminodiphenyl sulfone, 3,3′-oxydianiline, 3,4′-oxydianiline, 1,5-diaminonaphthalene, 4,4′-diaminodiphenylsilane, 4,4′-diaminodiphenylethylphosphine oxide, 4,4′-diaminodiphenyl-N-methylamine, 4,4′-diaminodiphenyl-N-phenylamine, 1,3-diaminobenzene, 1,2-diaminobenzene, bis{4-(4-aminophenoxy)phenyl}sulfone, bis{4-(4-aminophenoxy)phenyl}propane, bis{4-(3-aminophenoxy)phenyl}sulfone, 4,4′-bis(4-aminophenoxy)biphenyl, 4,4′-bis(3-aminophenoxy)biphenyl, 1,3-bis(3-aminophenoxy)benzene, 1,3-bis(4-aminophenoxy)benzene, 3,3′-diaminobenzophenone, and 4,4′-diaminobenzophenone, because they are easily industrially obtained. They may be used alone or as a mixture of two or more kinds.

In the present invention, the content of the 3,3′,4,4′-biphenyltetracarboxylic acid dianhydride is not particularly limited, and it is included in a content of preferably 10 to 100% by mol, more preferably 20 to 90% by mol, and further more preferably 30 to 70% by mol relative to 100% by mol of the total molar number of the tetracarboxylic acid dianhydride, because a conductive polyimide film having a desired conductivity can be obtained.

In the present invention, the content of the 4,4′-oxydianiline is not particularly limited, and it is preferably included in a content of preferably 50 to 100% by mol, more preferably 60 to 95% by mol, and further more preferably 70 to 90% by mol relative to 100% by mol of the total molar number of the diamine compound, because a conductive polyimide film having a desired conductivity can be easily obtained.

In the present invention, the 3,3′,4,4′-benzophenonetetracarboxylic acid dianhydride may not be necessarily included, if the p-phenylenediamine is included, but it is preferable to include it, because a conductive polyimide film whose pin hole generation is inhibited can be easily obtained. The content thereof is not particularly limited, and it is included in a content of preferably 90% by mol or less, more preferably 10 to 80% by mol, and further more preferably 30 to 70% by mol relative to 100% by mol of the total molar number of the tetracarboxylic acid dianhydride.

In the present invention, the p-phenylenediamine may not be necessarily included if the 3,3′,4,4′-benzophenonetetracarboxylic acid dianhydride is included, but it is preferable to include it, because a conductive polyimide film whose pin hole generation is inhibited can be easily obtained. The content thereof is not particularly limited, and it is included in a content of preferably 50% by mol or less, more preferably 5 to 40% by mol, and further more preferably 5 to 30% by mol relative to 100% by mol of the total molar number of the diamine compound.

For manufacturing the polyamic acid, any known method can be used, and it is usually manufactured by dissolving a tetracarboxylic acid dianhydride and a diamine compound in an organic solvent in a substantial equal molar amount to each other, and stirring the solution under a controlled temperature condition until the polymerization of the tetracarboxylic acid dianhydride and the diamine compound is completed.

As the preferable solvent for synthesizing the polyamic acid, any solvent can be used so long as it can dissolve the polyamic acid, and the solvent may include amide polar organic solvents, i.e., N,N-dimethylformamide, N,N-diethylformamide, N,N-dimethylacetamide, N-methyl-2-pyrrolidone, and the like. The N,N-dimethylformamide and N,N-dimethylacetamide can be particularly preferably used. They may be used alone or as a mixture.

As a solvent other than the solvents described above, dimethyl sulfoxide, phenols such as cresol, phenol, and xylenol, benzonitrile, dioxane, butyrolactone, xylene, cyclohexane, hexane, benzene, toluene, and the like may be used. They may be used alone or as a mixture.

In usual, the polyamic acid solution has preferably a concentration of 5 to 35% by weight, and it is more preferable to obtain the solution having a concentration of 10 to 30% by weight. When the solution has such a concentration, an appropriate molecular weight and an appropriate solution viscosity can be obtained.

As the polymerization method, any known method and combination thereof may be used, i.e., there are methods as shown below:

1) a polymerization method in which a diamine compound is dissolved in a polar organic solvent, and it is reacted with tetracarboxylic acid dianhydride in a substantial equal mol to that of the diamine compound.

2) a method in which a tetracarboxylic acid dianhydride is reacted with a too small molar amount, compared to that of the tetracarboxylic acid dianhydride, of a diamine compound in a polar organic solvent to obtain a prepolymer having acid anhydride groups at the both ends, and subsequently polymerization is performed using the diamine compound so that the molar amounts of the tetracarboxylic acid dianhydride and the diamine compound are substantially equal to each other in the whole step.

3) a method in which a tetracarboxylic acid dianhydride is reacted with an excess molar amount, compared to that of the tetracarboxylic acid dianhydride, of a diamine compound in a polar organic solvent to obtain a prepolymer having amino groups at the both ends thereof, subsequently the diamine compound is additionally added thereto, and then polymerization is performed using the tetracarboxylic acid dianhydride so that the molar amounts of the tetracarboxylic acid dianhydride and the diamine compound are substantially equal to each other in the whole step.

4) a method in which a tetracarboxylic acid dianhydride is dissolved and/or dispersed in a polar organic solvent, and then polymerization is performed using a diamine compound so that the molar amounts of the two components are equal to each other.

5) a polymerization method in which a mixture including a tetracarboxylic acid dianhydride and a diamine compound in substantially equal molar amounts to each other is reacted in a polar organic solvent.

These methods may be used alone, or as a partial combination thereof.

It is also known that, in order to increase a degree of polymerization, an optimal amount of an organic acid or an inorganic acid is added to a reaction solution, and this procedure can be applied to the present invention. The organic acid may include formic acid, acetic acid, propionic acid, butyric acid, and the like. The inorganic acid may include phosphoric acid, carbonic acid, and the like. They may be used alone or as a mixture of two or more kinds.

The amount of the organic acid or the inorganic acid used for increasing the degree of polymerization is not unmistakable decided. For example, it is only necessary to add the acid in an amount of 50 parts by weight or less, and more preferably 10 parts by weight or less based on 100 parts by weight of the polar organic solvent. Even if the amount is adjusted to more than 50 parts by weight, not only the effect obtained by the addition of the organic acid or inorganic acid cannot be more improved but also the resulting polyamic acid may be undesirably decomposed.

The agent (B) for imparting conductivity used in the manufacture method of the present invention is not particularly limited. Any known conductive filler, which can be included in a filler conductive resin composition generally called, can be used, and it may include, for example, aluminum particles, SUS particles, carbon conductive particles, silver particles, gold particles, copper particles, titanium particles, alloy particles, and the like. Of these, the carbon conductive particles can be preferably used, because they have a small specific gravity, and thus the weight saving of the conductive film can be easily realized. The carbon conductive particles may include Ketjen black, acetylene black, oil furnace black, carbon nanotube, and the like, and it is particularly preferable to use the Ketjen black and carbon nanotube, because they have a comparatively high conductivity as they are, and a high conductivity can be easily obtained by even a small amount of addition to a resin.

The agent for imparting conductivity is preferably included in an amount of 1 to 50 parts by weight and more preferably 5 to 20 parts by weight based on 100 parts by weight of the polyamic acid. When the amount is less than 1 part by weight, the conductivity may be reduced and thus the functions as the conductive film may sometimes be impaired, and when it is more than 50 parts by weight, the mechanical properties of the obtained conductive film may be reduced, thus resulting in difficulty of the handling.

The conjugation of the polyamic acid and the agent for imparting conductivity, i.e., the preparation of the polyamic acid solution in which an agent for imparting conductivity is dispersed may include, for example, the following methods:

1. A method in which the agent for imparting conductivity is added to a polymerization reaction liquid before or during the polymerization.

2. A method in which after the completion of the polymerization, the resulting product is kneaded with the agent for imparting conductivity using a three-rollers milling machine, or the like.

3. A method in which a dispersion including the agent for imparting conductivity is prepared, and it is mixed with the polyamic acid solution.

Any method can be applied. The method in which the dispersion including the agent for imparting conductivity is mixed with the polyamic acid solution, particularly a method in which the mixing is performed immediately before the coating film is manufactured, is preferable, because contamination of a manufacture line with the agent for imparting conductivity can be inhibited to the minimum. When the dispersion including the agent for imparting conductivity is prepared, it is preferable to use the same solvent as the polymerization solvent for the polyamidic acid. In order to sufficiently disperse the agent for imparting conductivity and stabilize the dispersed state, a dispersant or a thickener may be added within a range where the physical properties of the film are not impaired. It is preferable to add a small amount of the polyamic acid solution, which is a precursor of the polyimide, as the dispersant, because it is easy to stably disperse the agent for imparting conductivity without aggregation thereof.

In the conjugation described above, it is preferable to use a ball mill, beads mill, sand mill, colloid mill, jet mill, roller mill, or the like. When the dispersion is performed so that the resulting product becomes in a liquid state with fluidity by a method using the beads mill or ball mill, the polyamic acid solution in which the agent for imparting conductivity is dispersed can be easily handled in the film-forming step. The media diameter is not particularly limited, and it is preferably 10 mm or less.

The filler may be used in order to improve film properties of the obtained conductive polyimide film, such as slippage, sliding property, thermal conductivity, corona resistance, and loop stiffness. Any filler may be used, and examples of the preferable filler may include silica, titanium oxide, alumina, silicon nitride, boron nitride, calcium hydrogen phosphate, calcium phosphate, mica, and the like.

The particular diameter of the filler is not particularly limited, and is appropriately decided depending on the film property to be improved and the kind of the filler added. In general, the average particle diameter is preferably from 0.05 to 100 μm, more preferably from 0.1 to 75 μm, further more preferably from 0.1 to 50 μm and particularly preferably from 0.1 to 25 μm. When the particle diameter is less than 0.05 μm, it may be difficult to express the modification effects, and when it is more than 100 μm, the surface property may be greatly impaired or the mechanical properties may be markedly reduced.

The amount of the filler added is not also particularly limited, and is decided depending on the film property to be improved, the particle diameter of the filler, and the like. In general, the amount of the filler added is preferably from 0.01 to 100 parts by weight, more preferably from 0.01 to 90 parts by weight, and further more preferably from 0.02 to 80 parts by weight based on 100 parts by weight of the polyimide. When the addition amount of the filler is less than 0.01 parts by weight, it may be difficult to express the modification effects by adding the filler, and when it is more than 100 parts by weight, the mechanical properties of the film may sometimes be greatly impaired.

As an addition method of the filler, the same manner as described in the conjugation and dispersion method described above can be adopted, and the filler may be added at the time when the agent for imparting conductivity is conjugated and dispersed, or may be separately added.

The manufacture method of the present invention is the chemical imidation using the imidation accelerator, and the drying takes only a short time because the polyamic acid is converted into the polyimide, and thus the productivity is excellent.

The imidation accelerator (C) used in the present invention is characterized by using the dialkylpyridine as a catalyst and acetic anhydride as a chemical dehydrating agent.

The dialkylpyridine may include, for example, 2,3-dimethylpyridine, 2,4-dimethylpyridine, 2,5-dimethylpyridine, 2,6-dimethylpyridine, 3,4-dimethylpyridine, 3,5-dimethylpyridine, 3,5-diethylpyridine, 2-methyl-5-ethyl pyridine, and the like. These compounds may be used alone or as a mixture of two or more kinds.

The amount of the dialkylpyridine used is preferably from 0.1 to 4.0 molar equivalents, more preferably from 0.3 to 3.0 molar equivalents and further more preferably from 0.5 to 2.0 molar equivalents per mol of the amic acid in the polyamic acid. When the amount is less than 0.1 molar equivalents, the action as the catalyst is insufficient, and thus troubles such as film breakage and reduction of mechanical properties may sometimes occur during a drying and baking process. On the other hand, when it is more than 4.0 molar equivalents, the imidation may sometimes proceed too fast, thus resulting in difficulty of handling.

In the present invention, a tertiary amine compound other than the dialkylpyridine may be used as the catalyst together with the dialkylpyridine in a range where the effects of the present invention are not impaired. It is possible to use, for example, quinoline, isoquinoline, α-picoline, β-picoline, γ-picoline, and the like.

In the present invention, acetic anhydride is used as the chemical dehydrating agent.

The amount of the acetic anhydride used is from 0.1 to 1.6 molar equivalents, preferably from 0.2 to 1.5 molar equivalents, more preferably from 0.3 to 1.4 molar equivalents, further more preferably from 0.3 to 1.3 molar equivalents, and particularly preferably from 0.3 to 0.99 molar equivalents per mol of the amic acid in the polyamic acid. When the amount is less than 0.1 molar equivalents, the imidation caused by the action of the chemical dehydrating agent is insufficient, and thus the film breakage occurs and the mechanical properties are reduced during the drying and baking process. On the other hand, when it is more than 1.6 molar equivalents, the imidation may sometimes proceed too fast, thus resulting in difficulty of handling, and furthermore, troubles such as the film breakage and the reduction of the mechanical properties occur during the drying and baking process.

In the present invention, an aliphatic acid anhydride, an aromatic acid anhydride, a halogenated lower aliphatic acid anhydride, or the like may be used in addition to the acid anhydride for the chemical dehydrating agent in a range where the effects of the present invention are not impaired.

The imidation accelerator (C) used in the present invention may include a solvent. It is preferable that the solvent is the same kind of solvent as those included in the polyamic acid solution.

The temperature of the imidation accelerator (C) when it is added to the polyamic acid (A) is preferably 10° C. or lower, more preferably 5° C. or lower, and further more preferably 0° C. or lower. When the temperature is higher than 10° C., the imidation proceeds too fast, thus resulting in the difficulty of handling.

According to the manufacture method of the present invention, the coating film including the polyamic acid (A), the agent (B) for imparting conductivity, and the imidation accelerator (c) is dried and imidated, thereby forming a conductive polyimide film.

As the coating method to form the coating film, a known method such as a die coating method, a spraying method, a roll coating method, a rotary coating method, a bar coating method, an ink-jet method, a screen printing method, or a slit coating method can be appropriately adopted. The coating film is formed on a support such as a metal drum or a metal belt according to any of the coating methods described above, a dried self-sustainable film is obtained at a temperature of room temperature to about 200° C., and then the resulting film is fixed and heated to a final temperature of about 600° C., thereby obtaining the conductive polyimide film. For fixing the film, a known method such as a pin tenter method, a clip tenter method, or a roll suspension method can be employed, and the form thereof is not limited.

The heating temperature can be appropriately set. When a high temperature is selected, the imidation proceeds fast, and thus the time of a curing step can be shortened, and it is preferable in terms of the productivity. If the temperature is too high, however, thermal decomposition may occur. On the other hand, if the temperature is too low, the imidation proceeds slow, and thus a lot of time is necessary for the curing step.

The heating time is a time enough for substantial completion of the imidation and drying, and is not unmistakably limited. In general, the time is appropriately set within a range of about 1 to 900 seconds.

According to the manufacture method of the present invention, a thickness of the conductive polyimide film can be appropriately set by appropriately controlling a thickness of the coating film on the support, a concentration of the polyamic acid, or an amount in parts by weight of the agent for imparting conductivity. The thickness of the coating film is preferably from 1 to 1000 μm. When the thickness is less than 1 μm, the mechanical properties of the film may sometimes be reduced, and when it is more than 1000 μm, it may sometimes be difficult to control the thickness because of the occurrence of flow on the support. The final thickness of the conductive polyimide film is preferably from 1 to 100 μm, and more preferably from 5 to 50 μm. When the thickness is less than 1 μm, the mechanical properties of the film may sometimes be insufficient, and when it is more than 100 μm, the uniform imidation and drying are likely to become difficult, and thus the mechanical properties may sometimes be ununiform, or local defects such as foaming may sometimes easily occur.

The conductive polyimide film obtained by the manufacture method of the present invention realizes an electric resistivity which is equivalent to that of a conductive polyimide film obtained by a thermal imidation method, and moreover the productivity can be more markedly improved than the thermal imidation method. In addition, in the conductive polyimide film obtained by the manufacture method of the present invention, the generation of pin holes is effectively inhibited. According to the manufacture method of the present invention, the kind of the polyimide, and the kind and the amount of the agent for imparting conductivity can be appropriately set, and thus a volume resistivity in the thickness direction and a surface resistivity of the obtained conductive polyimide film can be controlled as desired.

The volume resistivity in the thickness direction of the conductive polyimide film is preferably within a range of 1.0×10⁻¹ to 1.0×10² Ωcm, more preferably 1.0×10⁻¹ to 8.0×10¹ Ωcm, and further more preferably 1.0×10⁻¹ to 5.0×10¹ Ωcm, in terms of the usefulness as a substitute for a metal electronic material. The surface resistivity of the conductive polyimide film is preferably within a range of 1.0×10¹ to 1.0×10⁴ Ω/□, more preferably 1.0×10¹ to 5.0×10³ Ω/□, and further more preferably 1.0×10¹ to 3.0×10³ Ω/□.

The conductive polyimide film obtained by the manufacture method of the present invention has a tear propagation resistance of preferably 130 g/mm (1.27 N/mm) or more, more preferably 132 g/mm (1.29 N/mm) or more, and further more preferably 135 g/mm (1.32 N/mm), in terms of the stable performance of the film sending during the film formation.

According to the manufacture method of the present invention, a conductive polyimide film, which is preferable for metal electronic materials, electromagnetic shielding materials, electrostatic attracting films, anti-static agents, parts for an image formation device, materials for a battery electrode, electronic devices, and the like, can be stably manufactured and supplied.

### EXAMPLE

the effects of the present invention are specifically explained with reference to Examples and Comparative Examples, but the present invention is not limited thereto. Those skilled in the art can make various changes, modifications or alterations without exceeding the scope of the present invention.

An edge strength, a volume resistivity, a surface resistivity, a tear propagation resistance, and a generation rate of pin holes of a conductive polyimide film, obtained in each of Examples and Comparative Examples, were measured and evaluated as follows:

### (Edge Strength)

An edge part of a film, which was fixed on a pin frame when the film is dried, was stretched with hands. The strength of the edge part was defined as an edge strength.

◯: The film edge part has a strength equivalent to or higher than that of an edge part of a film from Reference Example 2.
x: The film edge part is brittler than the edge part of the film from Reference Example 2, and is easily cut.

### (Volume Resistivity)

The obtained conductive polyimide film was cut into a 15 mm□ size, and gold thin films were formed in areas of 10 mm□ at central parts of the both faces by a sputtering method. A potential V was measured at the time when a copper foil was closely fitted to each gold thin film by applying a pressure of 1 MPa thereto, and a current I was passed between the two copper foils, and a value of measured V/I was defined as a volume resistivity. For measurement of a resistance, LCR HiTESTER (3522-50 manufactured by Hioki E. E. Corporation) was used.

### (Surface Resistivity)

Using LORESTA-GP (MCP-T610 manufactured by Mitsubishi Analytech Co., Ltd.) for the measurement, a surface resistivity was measured by pressing a four-point probe against the surface of the obtained conductive polyimide film.

### (Tear Propagation Resistance)

A tear propagation resistance of the obtained conductive polyimide film was measured in accordance with JIS K 7128 Trauzer Tear Method.

### (Generation Rate of Pin Holes)

A light source was applied to the film manufactured from the back thereof, and the number of rays of light piercing through the film, which were regarded as the presence of a pin hole, was counted. An average generation rate of pin holes per m² of the film was calculated from the number of the rays counted in an area of 0.12 m² of the film. A xenon light (ULTRA STINGER manufactured by Stream Co., Ltd.) was used as the light source. When the number of the pin holes generated was 10 or less per m², it was evaluated that the generation of pin holes was inhibited.

### Synthesis Example 1

N,N-dimethylformamide (DMF) was used as the organic solvent for polymerization, 50% by mol of 3,3′,4,4′-biphenyltetracarboxylic acid dianhydride (BPDA) and 50% by mol of 3,3′,4,4′-benzophenonetetracarboxylic acid dianhydride (BTDA) were used as the tetracarboxylic acid dianhydride, and 85% by mol of 4,4′-oxydianiline (ODA) and 15% by mol of p-phenylenediamine (p-PDA) were used as the diamine compound. The components were added to a reaction chamber in the contents in % by mol of the tetracarboxylic acid dianhydride and the diamine compound substantially equal to each other, and the mixture was stirred and polymerized, thereby synthesizing a polyamic acid solution. At that time, the synthesis was performed so that the obtained polyamic acid solution had a solid concentration of 15% by weight and a viscosity of 300 to 400 Pa·s (E-type viscometer manufactured by Toki Sangyo Co., Ltd: TVE-22H, Measurement Temperature: 23° C., Rotor: 3°×R14, Number of Revolutions: 1 rpm, Measurement Time: 120 seconds).

10 parts by weight of the obtained polyamic acid solution, 1 part by weight of Ketjen black (ECP 600 JD manufactured by Lion Corporation), and 20 parts by weight of DMF were subjected to a dispersion treatment in a ball mill, thereby obtaining a carbon dispersion. The dispersion was performed using 5 mm φ zirconia particles at the number of revolutions of 600 rpm for 30 minutes.

With 100 parts by weight of the obtained carbon dispersion was mixed 183 parts by weight of the obtained polyamic acid solution and the mixture was homogenized to obtain a carbon-dispersed polyamic acid solution. At that time, the amount of the Ketjen black was 10 parts by weight based on 100 parts by weight of the polyamic acid.

### Comparative Synthesis Example 1

N,N-dimethylformamide (DMF) was used as the organic solvent for polymerization, 100% by mol of 3,3′,4,4′-biphenyltetracarboxylic acid dianhydride (BPDA) was used as the tetracarboxylic acid dianhydride, and 100% by mol of 4,4′-oxydianiline (ODA) was used as the diamine compound. The components were added to a reaction chamber in the contents in % by mol of the tetracarboxylic acid dianhydride and the diamine compound substantially equal to each other, and the mixture was stirred and polymerized, thereby synthesizing a polyamic acid solution. At that time, the synthesis was performed so that the obtained polyamic acid solution had a solid concentration of 15% by weight and a viscosity of 300 to 400 Pa·s (E-type viscometer manufactured by Toki Sangyo Co., Ltd: TVE-22H, Measurement Temperature: 23° C., Rotor: 3°×R14, Number of Revolutions: 1 rpm, Measurement Time: 120 seconds).

10 parts by weight ob the obtained polyamic acid solution, 1 part by weight of Ketjen black (ECP 6700 JD manufactured by Lion Corporation), and 20 parts by weight of DMF were subjected to a dispersion treatment in a ball mill, thereby obtaining a carbon dispersion. The dispersion was performed using 5 mm φ zirconia particles at the number of revolutions of 600 rpm for 30 minutes.

With 100 parts by weight of the obtained carbon dispersion was mixed 183 parts by weight of the obtained polyamic acid solution and the mixture was homogenized to obtain a carbon-dispersed polyamic acid solution. At that time, the amount of the Ketjen black was 10 parts by weight based on 100 parts by weight of the polyamic acid.

### Example 1

An imidation accelerator including 8.7 g (64.3 mmol) of 3,5-diethylpyridine, 4.2 g (41.1 mmol, 0.9 molar equivalents per mol of the amic acid) of acetic anhydride, and 6.7 g of DMF was added to 100 g (including 46.1 mmol of the amic acid) of the carbon-dispersed polyamic acid solution obtained in Synthesis Example 1, and the mixture was homogenized. The resulting product was flow-casted in a width of 40 cm on an aluminum foil so that a final thickness was 25 μm, and the film was dried at 120° C. for 216 seconds, thereby obtaining a self-sustainable film. After the self-sustainable film was peeled off from the aluminum foil, the film was fixed with pins, and it was dried at 250° C. for 200 seconds, and subsequently at 400° C. for 64 seconds, thereby obtaining a conductive polyimide film. The edge strength, volume resistivity, surface resistivity, tear propagation resistance, and generation rate of pin holes of the obtained conductive polyimide film were measured. The results are shown in Table 1.

### Example 2

An imidation accelerator including 8.7 g (64.3 mmol) of 3,5-diethylpyridine, 2.4 g (23.0 mmol, 0.5 molar equivalents per mol of the amic acid) of acetic anhydride, and 8.5 g of DMF was added to 100 g (including 46.1 mmol of the amic acid) of the carbon-dispersed polyamic acid solution obtained in Synthesis Example 1, and the mixture was homogenized. The resulting product was flow-casted in a width of 40 cm on an aluminum foil so that a final thickness was 25 μm, and the film was dried at 120° C. for 216 seconds, thereby obtaining a self-sustainable film. After the self-sustainable film was peeled off from the aluminum foil, the film was fixed with pins, and it was dried at 250° C. for 200 seconds and subsequently at 400° C. for 64 seconds, thereby obtaining a conductive polyimide film. The edge strength, volume resistivity, surface resistivity, tear propagation resistance, and generation rate of pin holes of the obtained conductive polyimide film were measured. The results are shown in Table 1.

### Example 3

An imidation accelerator including 8.7 g (81.2 mmol) of 3,5-dimethylpyridine, 4.2 g (41.1 mmol, 0.9 molar equivalents per mol of the amic acid) of acetic anhydride, and 6.7 g of DMF was added to 100 g (including 46.1 mmol of the amic acid) of the carbon-dispersed polyamic acid solution obtained in Synthesis Example 1 and the mixture was homogenized. The resulting product was flow-casted in a width of 40 cm on an aluminum foil so that a final thickness was 25 μm, and the film was dried at 120° C. for 216 seconds, thereby obtaining a self-sustainable film. After the self-sustainable film was peeled off from the aluminum foil, the film was fixed with pins, and it was dried at 250° C. for 200 seconds and subsequently at 400° C. for 64 seconds, thereby obtaining a conductive polyimide film. The edge strength, volume resistivity, surface resistivity, tear propagation resistance, and generation rate of pin holes of the obtained conductive polyimide film were measured. The results are shown in Table 1.

### Comparative Example 1

An imidation accelerator including 8.7 g (64.3 mmol) of 3,5-diethylpyridine, 8.7 g (85.2 mmol, 1.8 molar equivalents per mol of the amic acid) of acetic anhydride, and 6.7 g of DMF was added to 100 g (including 46.1 mmol of the amic acid) of the carbon-dispersed polyamic acid solution obtained in Synthesis Example 1 and the mixture was homogenized. The resulting product was flow-casted in a width of 40 cm on an aluminum foil so that a final thickness was 25 μm, and the film was dried at 120° C. for 216 seconds, thereby obtaining a self-sustainable film. After the self-sustainable film was peeled off from the aluminum foil, the film was fixed with pins, and it was dried at 250° C. for 200 seconds and subsequently at 400° C. for 64 seconds. Some of the parts fixed with the pin of the film were broken.

### Comparative Example 2

An imidation accelerator including 8.7 g (81.2 mmol) of 3,5-dimethylpyridine, 9.6 g (94.0 mmol, 2.0 molar equivalents per mol of the amic acid) of acetic anhydride, and 5.0 g of DMF was added to 100 g (including 46.1 mmol of the amic acid) of the carbon-dispersed polyamic acid solution obtained in Synthesis Example 1 and the mixture was homogenized. The resulting product was flow-casted in a width of 40 cm on an aluminum foil so that a final thickness was 25 μm, and the film was dried at 120° C. for 216 seconds, thereby obtaining a self-sustainable film. After the self-sustainable film was peeled off from the aluminum foil, the film was fixed with pins, and it was dried at 250° C. for 200 seconds and subsequently at 400° C. for 64 seconds. Some of the parts fixed with the pin of the film were broken.

### Comparative Example 3

An imidation accelerator including 12.4 g (91.6 mmol) of 3,5-diethylpyridine, 9.3 g (91.3 mmol, 2.0 molar equivalents per mol of the amic acid) of acetic anhydride, and 7.3 g of DMF was added to 100 g (including 46.1 mmol of the amic acid) of carbon-dispersed polyamic acid solution obtained in Comparative synthesis Example 1, and the mixture was homogenized. The resulting product was flow-casted in a width of 40 cm on an aluminum foil so that a final thickness was 12.5 μm, and the film was dried at 120° C. for 70 seconds, thereby obtaining a self-sustainable film. After the self-sustainable film was peeled off from the aluminum foil, the film was fixed with pins, and it was dried at 300° C. for 11 seconds and subsequently at 450° C. for 60 seconds. Some of the parts fixed with the pin of the film were broken.

### Reference Example 1

An imidation accelerator including 8.3 g (64.3 mmol) of isoquinoline, 2.4 g (23.0 mmol, 0.5 molar equivalents per mol of the amic acid) of acetic anhydride, and 8.7 g of DMF was added to 100 g (including 46.1 mmol of the amic acid) of the carbon-dispersed polyamic acid solution obtained in Synthesis Example 1, and the mixture was homogenized. The resulting product was flow-casted in a width of 40 cm on an aluminum foil so that a final thickness was 25 μm, and the film was dried at 120° C. for 216 seconds, thereby obtaining a self-sustainable film. The self-sustainable film could not be peeled off from the aluminum foil, and thus a conductive polyimide film could not be obtained.

### Reference Example 2

An imidation accelerator including 8.3 g (64.3 mmol) of isoquinoline, 8.3 g (81.3 mmol, 1.8 molar equivalents per mol of the amic acid) of acetic anhydride, and 5.5 g of DMF was added to 100 g (including 46.1 mmol of the amic acid) of the carbon-dispersed polyamic acid solution obtained in Synthesis Example 1, and the mixture was homogenized. The resulting product was flow-casted in a width of 40 cm on an aluminum foil so that a final thickness was 25 μm, and the film was dried at 120° C. for 216 seconds, thereby obtaining a self-sustainable film. After the self-sustainable film was peeled off from the aluminum foil, the film was fixed with pins, and it was dried at 250° C. for 200 seconds and subsequently at 400° C. for 64 seconds, thereby obtaining a conductive polyimide film. The edge strength, volume resistivity, surface resistivity, tear propagation resistance, and generation rate of pin holes of the obtained conductive polyimide film were measured. The results are shown in Table 1.

TABLE 1

| | | | | Tear | Number of |
|---|---|---|---|---|---|
| | | Surface | Volume | propagation | pin holes |
| | Edge | resistivity | resistivity | resistance | (pin holes/ |
| | strength | (Ω/□) | (Ωcm) | (g/mm) | m²) |
| Example 1 | ∘ | 804 | 9 | 200 | 66 |
| Example 2 | ∘ | 770 | 7 | 216 | 75 |
| Example 3 | ∘ | 965 | 12 | 200 | 83 |
| Comparative | x | — | — | — | — |
| Example 1 | | | | | |
| Comparative | x | — | — | — | — |
| Example 2 | | | | | |
| Comparative | x | 1285 | 7 | — | 583 |
| Example 3 | | | | | |
| Reference | x | — | — | — | — |
| Example 1 | | | | | |
| Reference | ∘ | 967 | 16 | 216 | 42 |
| Example 2 | | | | | |

As shown in Table 1, it is seen that the conductive polyimide films of the present invention obtained in Examples 1 to 3 have the higher film strength than that of the films obtained in Comparative Examples 1 and 2 in which the amount of the acetic anhydride used is beyond the range defined in the present invention.

It is clear that in the conductive polyimide films of the present invention obtained in Examples 1 to 3, the generation of the pin holes is inhibited, compared to the conductive polyimide film obtained in Comparative Example 3 using the polyamic acid, which is obtained by reacting the 3,3′,4,4′-biphenyltetracarboxylic acid dianhydride as the tetracarboxylic acid dianhydride with the 4,4′-oxydianiline as the diamine compound.

It is seen that in the Examples 1 to 3 of the present invention, the obtained conductive polyimide films have the film strength and the electrical properties, which are equivalent to those of the conductive polyimide film obtained in Reference Example 2 in which the isoquinoline is used as the imidation accelerator, and the generation of the pin holes are inhibited on the film.

1. A method for manufacturing a conductive polyimide film including an agent for imparting conductivity and a polyimide resin, comprising:
drying a coating film which includes:
(A) a polyamic acid including 3,3′,4,4′-biphenyltetracarboxylic acid dianhydride, 4,4′-oxydianiline, and 3,3′,4,4′-benzophenonetetracarboxylic acid dianhydride and/or p-phenylenediamine,
which is obtained by reacting a tetracarboxylic acid dianhydride with a diamine compound,
(B) an agent for imparting conductivity, and
(C) an imidation accelerator including a dialkylpyridine, and 0.1 to 1.6 molar equivalents of acetic anhydride per mol of an amic acid in a polyamic acid; and
subjecting the film to imidation.

2. The method for manufacturing the conductive polyimide film according to claim 1, wherein the 3,3′,4,4′-biphenyltetracarboxylic acid dianhydride and the 3,3′,4,4′-benzophenonetetracarboxylic acid dianhydride are included in contents of 10 to 100% by mol and 0 to 90% by mol, respectively, relative to 100% by mol of the tetracarboxylic acid dianhydride, and the 4,4′-oxydianiline and the p-phenylenediamine are included in contents of 50 to 100% by mol and 0 to 50% by mol, respectively, relative to 100% by mol of the diamine compound.

3. The method for manufacturing the conductive polyimide film according to claim 1, wherein the agent (B) for imparting conductivity includes carbon conductive particles.

4. The method for manufacturing the conductive polyimide film according to claim 1, wherein the agent (B) for imparting conductivity is included in an amount of 1 to 50 parts by weight based on 100 parts by weight of the polyamic acid (A).

5. The method for manufacturing the conductive polyimide film according to claim 1, wherein the dialkylpyridine in the imidation accelerator (C) is used in an amount within a range of 0.1 to 4.0 molar equivalents per mol of the amic acid in the polyamic acid (A).

6. The method for manufacturing the conductive polyimide film according to claim 1, wherein the conductive polyimide film has a thickness within a range of 1 to 100 μm.

7. The method for manufacturing the conductive polyimide film according to claim 1, wherein the conductive polyimide film has a volume resistivity within a range of 1.0×10⁻¹ to 1.0×10² Ωcm in a thickness direction and/or a surface resistivity within a range of 1.0×10¹ to 1.0×10⁴ Ω/□.

8. The method for manufacturing the conductive polyimide film according to claim 1, wherein the conductive polyimide film has a tear propagation resistance within a range of 130 to 250 g/mm.
